(19) United States
(12) Patent Application Publication
(10) Pub. No.: US 2009/0283582 A1
(43) Pub. Date: Nov. 19, 2009

(54) SYSTEM AND METHOD FOR ESTABLISHING MEMBERSHIP

(76) Inventors: Luc Doan, Murrieta, CA (US); Richard Jude Dominguez, Temecula, CA (US); Michael Anthony Grimsley, Menifee, CA (US)

Correspondence Address: HOLLAND & KNIGHT LLP, 10 ST. JAMES AVENUE, BOSTON, MA, 02116-3889, US

(21) Appl. No.: 12/123,100

(22) Filed: May 19, 2008

(51) Int. Cl. G06F 17/00

(52) U.S. Cl. 235/375

(57) ABSTRACT

A method, system, and computer program product for defining identification information for a patron on a handheld device. The identification information for the patron is provided to an enrollment process.

### TECHNICAL FIELD

This disclosure relates to customer loyalty programs and, more particularly, to establishing membership within a customer loyalty program.

### BACKGROUND

Many businesses today maintain customer loyalty programs. A patron may become a member of the program by merely signing up for it, typically by providing his or her name and address to the business. A membership card may be given to the patron and subsequently scanned/swiped upon each visit to or each transaction within the business. The patron may benefit from the membership by receiving discounts and promotional offers. The business may benefit from the program by being able to keep track of valuable market data. This may include information such as: how much money an individual is spending at the business, what products/services are more likely to be popular with people from various regions, how one product correlates to another (e.g., do people who like Product A also like Product B?), what promotional mailings are working, and many others.

In some cases, when a patron who is not a member of the customer loyalty program frequents a business (or visits the business only one time but spends a considerable amount of money), it may be desirable for the business to enroll the patron as a member of the customer loyalty program and provide a membership card to the patron. Unfortunately, in some environments (e.g., a casino), the patron may not want to take the time to enroll in the customer loyalty program. In such a case, it may be desirable to provide a convenient and quick method of establishing membership in the program. Additionally, if the patron has to leave his location in order to enroll in the program, the time spent is time that the patron might have otherwise been spending money in the business, thus reducing the business's revenues.

### SUMMARY OF THE DISCLOSURE

In a first implementation, a method includes defining identification information for a patron on a handheld device and providing the identification information for the patron to an enrollment process.

One or more of the following features may be included. Defining identification information for a patron may include processing encoded identification data included within one or more of a magnetic strip, a bar code, an optical code, an image scan, a text scan, a fingerprint scan, a retinal scan, and an image of facial likeness. At least a portion of the encoded identification data may be retrieved from one or more of a driver's license, a membership card, a passport, a social security card, a government-issued identification, and a privately-issued identification.

Providing the identification information for the patron to the enrollment process may include wirelessly transmitting the identification information for the patron to the enrollment process. An account may be generated and associated with the patron. A membership card may be generated and associated with an account. A personal identification number may be associated with one or more of an account and a membership card.

In another implementation, a system is configured to perform operations including defining identification information for a patron on a handheld device and providing the identification information for the patron to an enrollment process.

One or more of the following features may be included. Defining identification information for a patron may include processing encoded identification data included within one or more of a magnetic strip, a bar code, an optical code, an image scan, a text scan, a fingerprint scan, a retinal scan, and an image of facial likeness. At least a portion of the encoded identification data may be retrieved from one or more of a driver's license, a membership card, a passport, a social security card, a government-issued identification, and a privately-issued identification.

Providing the identification information for the patron to the enrollment process may include wirelessly transmitting the identification information for the patron to the enrollment process. An account may be generated and associated with the patron. A membership card may be generated and associated with an account. A personal identification number may be associated with one or more of an account and a membership card.

In another implementation, a computer program product resides on a computer readable medium that has a plurality of instructions stored on it. When executed by a processor, the instructions cause the processor to perform operations including defining identification information for a patron on a handheld device and providing the identification information for the patron to an enrollment process.

One or more of the following features may be included. Defining identification information for a patron may include processing encoded identification data included within one or more of a magnetic strip, a bar code, an optical code, an image scan, a text scan, a fingerprint scan, a retinal scan, and an image of facial likeness. At least a portion of the encoded identification data may be retrieved from one or more of a driver's license, a membership card, a passport, a social security card, a government-issued identification, and a privately-issued identification.

Providing the identification information for the patron to the enrollment process may include wirelessly transmitting the identification information for the patron to the enrollment process. An account may be generated and associated with the patron. A membership card may be generated and associated with an account. A personal identification number may be associated with one or more of an account and a membership card.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an enrollment process coupled to a distributed computing network; and

FIG. 2 is a flowchart of the enrollment process of FIG. 1.

Like reference symbols in the various drawings indicate like elements.

### DETAILED DESCRIPTION OF THE DISCLOSURE

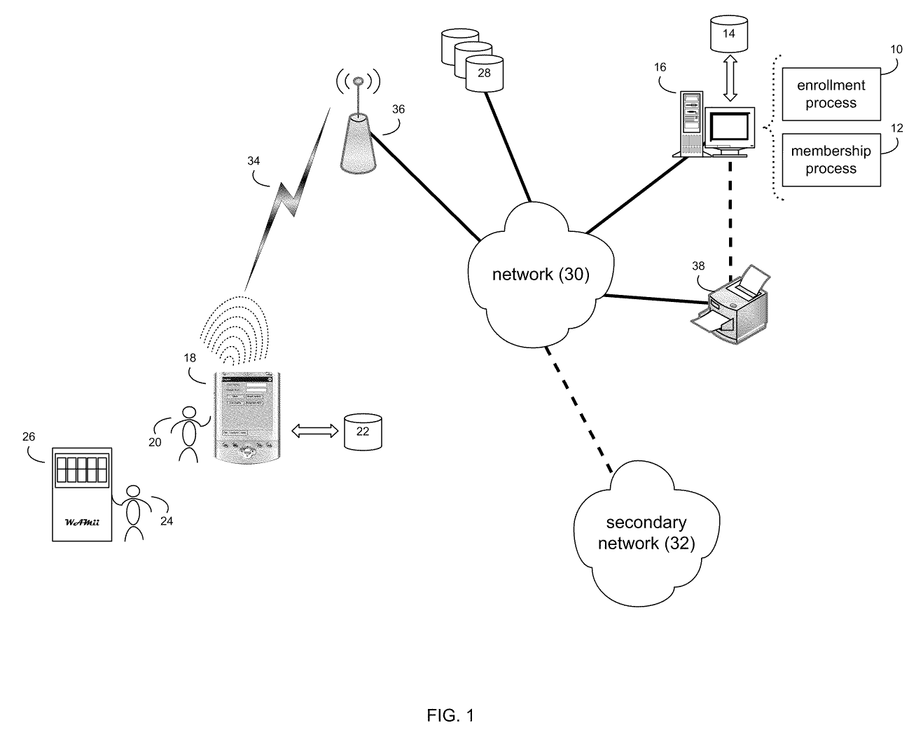

Referring to FIG. 1, there is shown enrollment process 10. Enrollment process 10 may interface with (or be a portion of) membership process 12, wherein enrollment process 10 may allow patrons to e.g., enroll in a customer loyalty program. Examples of such customer loyalty programs may include but are not limited to a Player's Club within a casino, a frequent flyer account, a hotel rewards club account, or a grocery store “valued customer” account.

The instruction sets and subroutines of membership process 12, which may be stored on storage device 14 coupled to computer 16, may be executed by one or more processors (not shown) and one or more memory architectures (not shown) incorporated into computer 16. Examples of storage device 14 may include but are not limited to: a hard disk drive; a tape drive; an optical drive; a RAID array; a random access memory (RAM); and a read-only memory (ROM). Examples of computer 16 may include, but are not limited to: a personal computer, a server computer, a series of server computers, a mini computer, and a mainframe computer. Computer 24 may be a single server or a series of servers running a network operating system, examples of which may include but are not limited to: Microsoft Windows 2003 Server™; Novell Netware™; or Redhat Linux™, for example.

Enrollment process 10 may be executed (in whole or in part) by a handheld electronic device (e.g. handheld electronic device 18) controllable by employee 20. Examples of handheld electronic device 18 may include but are not limited to a personal digital assistant, a data enabled cellular telephone, or a custom electronic device. Enrollment process 10 may include a client-side process (i.e. a process executed by handheld electronic device 18; not shown) and/or a server-side process (i.e. a process executed by computer 16; not shown). For example, handheld electronic device 18 may execute a client-side process (which is a portion of enrollment process 10) that is in communication with a server-side process (which is also a portion of enrollment process 10) that is executed on computer 16.

Handheld electronic device 18 may execute an operating system, examples of which may include but are not limited to: Microsoft Windows™, Microsoft Windows CE™, Redhat Linux™, PalmOS™, Apple Mac OS X™, or a custom operating system.

The instruction sets and subroutines of any client-side process of enrollment process 10, which may be stored on storage device 22 coupled to handheld electronic device 18, may be executed by one or more processors (not shown) and one or more memory architectures (not shown) incorporated into handheld electronic device 18. Examples of storage device 22 may include but are not limited to: a hard disk drive; a random access memory (RAM); a read-only memory (ROM), and a flash memory device.

The instruction sets and subroutines of any server-side process of enrollment process 10, which may be stored on storage device 14 coupled to computer 16, may be executed by one or more processors (not shown) and one or more memory architectures (not shown) incorporated into computer 16. Examples of storage device 14 may include but are not limited to: a hard disk drive; a tape drive; an optical drive; a RAID array; a random access memory (RAM); and a read-only memory (ROM).

As will be discussed below in greater detail, when a patron (e.g. patron 24) visits a business, employee 20 of the business may ask patron 24 if they would like to join the above-described customer loyalty program. Assume for illustrative purposes that the above-described business is a casino and that the above-described customer loyalty program is a Player's Club. Accordingly, at some point while patron 24 is visiting the casino, employee 20 may ask patron 24 if they would like to become a member of the above-described Player's Club. For example, upon first entering the casino, employee 20 may ask patron 24 if they wish to become a member of the above-described Player's Club. Alternatively, employee 20 may approach patron 24 while they are playing an electronic gaming device (e.g., electronic gaming device 26). Further, if patron 24 is traveling to the casino via mass transit (e.g. a casino-sponsored/casino-owned bus), employee 20 may approach patron 24 while they are traveling on the bus to the casino.

Accordingly, by allowing employee 20 to access enrollment process 10 via handheld electronic device 18, employee 20 may enroll patron 24 into the above-described Player's Club during times when patron 24 is not on the casino floor (e.g. when patron 24 first enters the casino or patron 24 is traveling to the casino) or in a manner that minimizes the interruption to patron 24 while they are on the casino floor (e.g. by allowing patron 24 to enroll in the above-described Player's Club via enrollment process 10 while they are on the casino floor, as opposed requiring them to leave the casino floor).

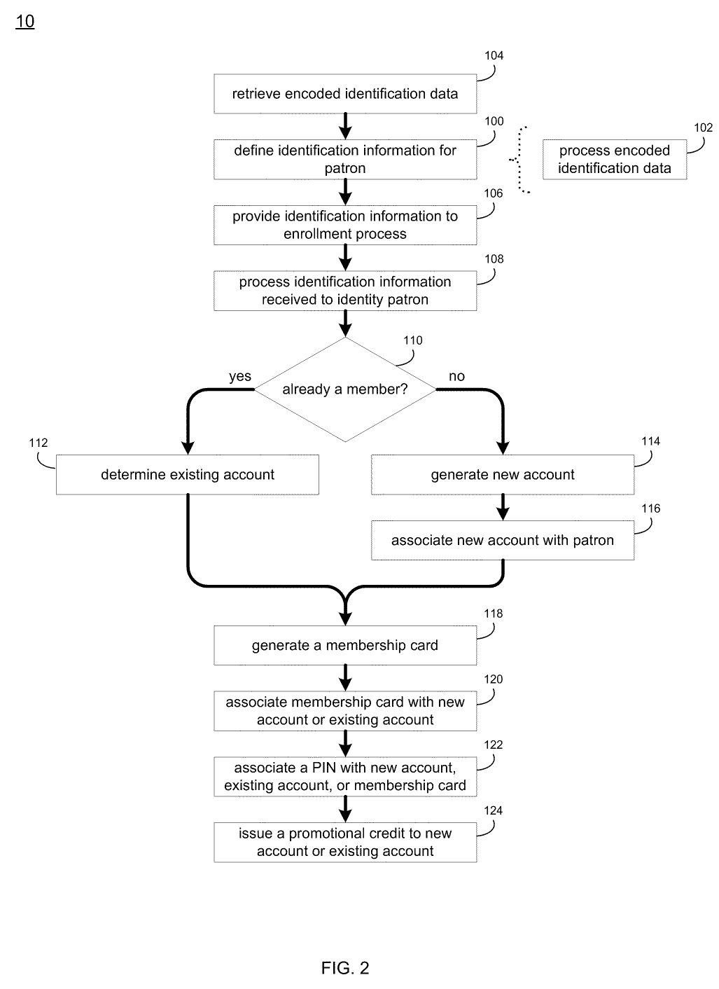

Referring also to FIG. 2, in the event that patron 24 indicates that they would like to join the Player's Club, employee 20 may define 100 identification information sufficient to identify patron 24. Defining 100 the identification information may include processing 102 encoded identification data that is included within one or more of a magnetic strip, a bar code, an optical code, an image scan, a text scan, a fingerprint scan, a retinal scan, and an image of facial likeness.

For example, upon indicating that they would like to join the Player's Club, patron 24 may provide employee 20 with a form of identification that may include a magnetic strip, a barcode, an optical code, and/or a photograph that may be processed by handheld electronic device 18 so that the encoded identification data included within the magnetic strip, the barcode, the optical code, and/or the photograph may be retrieved 104 and processed 102 by enrollment system 10 to define 100 the identity of patron 24. Alternatively, a fingerprint scan may be made of one of the fingers of patron 14, and/or a retinal scan may be made of one of the eyes of patron 14, each of which may be subsequently processed 102 to define 100 the identity of patron 24. In order to effectuate the above-described magnetic strip scan, barcode scan, optical code scan, image scan, fingerprint scan, and/or retinal scan, handheld electronic device 18 may include one or more of a magnetic strip scanner, a barcode scanner, an optical code scanner, an image scanner, a fingerprint scanner, and/or a retinal scanner. Examples of the above-described form of identification may include but are not limited to a driver's license, a membership card, a passport, a Social Security card, a government-issued identification, and a privately issued identification.

As discussed above, handheld electronic device 18 may execute a client-side process (which is a portion of enrollment process 10) that is in communication with a server-side process (which is also a portion of enrollment process 10) that is executed on computer 16. Therefore, handheld electronic device 18 and/or computers 16 may be coupled to network 30, examples of which may include a private network, a public network, a local area network, or a wide-area network (e.g. the Internet). Further, network 30 may be coupled to one or more secondary networks (e.g. secondary network 32), which may be used to couple computers 16 to handheld electronic device 18.

Computer 16 may execute a webserver application, examples of which may include but are not limited to: Microsoft IIS™, Novell Webserver™, or Apache Webserver™, that allows for access to computer 16 via network 30 and/or network 32. Accordingly, handheld electronic device 18 may be directly or indirectly coupled to network 30 and/or network 32 (and therefore to enrollment process 10 and/or membership process 12). In this particular example, handheld electronic device 18 is shown wirelessly coupled to network 30 via wireless communication channel 34 established between handheld device 18 and wireless access point (WAP) 36, which is shown directly coupled to network 30. WAP 36 may be, for example, an IEEE 802.11a, 802.11b, 802.11g, Wi-Fi, IEEE 802.15, Bluetooth, and/or infrared device that is capable of establishing wireless communication channel 34 between handheld electronic device 18 and WAP 36. Alternatively, handheld electronic device 18 may be coupled to network 30 via a wired interface (not shown).

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless interface.

Additionally/alternatively, handheld electronic device 18 may be directly coupled to computer 16, without utilizing network 30 and/or network 32, via a wired communication channel (not shown), examples of which may include but are not limited to a Universal Serial Bus (i.e., USB) interface, an IEEE 1394 interface, a Firewire™ interface, an RS-232 interface, an IEEE 802.3 interface, an IEEE 802.5 interface, a parallel interface, serial interface, or LAN interface capable of coupling to computer 16.

Additionally/alternatively, data may be transferred from handheld electronic device 18 to computer 16 by one or more manual procedures, such as swapping a memory card (not shown) that contains the data to be transferred from handheld electronic device 18 to computer 16; or placing handheld electronic device 18 into a docking cradle (not shown) coupled to computer 16. As discussed above, if patron 24 is traveling to the casino via mass transit (e.g. a casino-sponsored/casino-owned bus), employee 20 may approach patron 24 while they are traveling on the bus to the casino. Accordingly, data obtained from the patron may be stored locally on the memory card (not shown) included within handheld electronic device 18 until the data is subsequently transferred to computer 16 (via e.g., the above-described memory card swapping procedure or the above-described docking procedure).

Continuing with the above-stated example, once the appropriate identification information (e.g. a magnetic strip scan, a barcode scan, an optical code scan, an image scan, a fingerprint scan, and/or a retinal scan) is defined 100, this identification information may be provided 106 (via a wired or wireless communication channel) to enrollment process 10. Once received by enrollment process 10, enrollment process 10 may process 108 the identification information received from handheld electronic device 18 so that enrollment process 10 may identify patron 24.

For example, the identification information received from handheld electronic device 18 may be compared with identification information included within one or more databases (e.g. database 28) so that the identity of patron 24 may be defined. Examples of database 28 may include but are not limited to a Division of Motor Vehicles database that may identify patron 24 via information encoded within their driver's license; a Social Security database that may identify patron 24 via a Social Security number; a photograph database that may identify patron 24 via the above-described image scan; a fingerprint database that may identify patron 24 via the above-described fingerprint scan; and a retinal scan database that may identify patron 24 via the above-described retinal scan. Accordingly, if the identification information received from handheld electronic device 18 is a California driver's license number, the California Division of Motor Vehicles database may be accessed to identify patron 24. Alternatively, the form of identification provided by patron 24 to employee 20 may not require database correlation. For example, the magnetic strip included within the California driver's license may simply identify the name and address of patron 24.

Upon employee 20 asking patron 24 if they would like to join the Player's Club, it is foreseeable that patron 24 may forget that they are already a member of the Player's Club. Alternatively, while patron 24 may realize that they are already a member of the Player's Club, they may not have their Player's Club identification card with them. Accordingly, once enrollment process 10 identifies patron 24, enrollment process 10 may interface with (e.g. query) membership process 12 to determine if 110 patron 24 is already a member of the Player's Club. This determination 110 may be made by comparing the identity of patron 24 with e.g. entries within the database that define members of the Player's Club.

If 110 it is determined that patron 24 is already a member of the Player's Club, patron 24 would already have a Player's Club account. Accordingly, enrollment process 10 may merely determine 112 the existing Player's Club account and may provide patron 24 with identification that allows patron 24 to identify their Player's Club account. For example, patron 24 may be provided with a temporary or replacement Player's Club card (not shown) that may be associated 120 with the existing Player's Club account of patron 24. Such a temporary or replacement Player's Club card may be generated 118 by e.g. printing device 38 coupled to e.g. network 30 and/or network 32. Alternatively, handheld electronic device 18 may be configured to generate 118 such a temporary or replacement Player's Club card.

Alternatively, if 110 it is determined that patron 24 is not a member of the Player's Club, enrollment process 10 may generate 114 a new Player's Club account and may associate 116 the newly-created Player's Club with patron 24. When generating 114 a new Player's Club account, patron 24 may be required to provide additional information based upon the rules of e.g. the casino. For example, patron 24 may be required to provide Social Security number information for income tax purposes. In the event that such additional information is needed, employee 20 may enter such additional information via handheld electronic device 18, were this additional information is transferred (via a wireless or wired communication channel) to enrollment process 10. As discussed above, enrollment process 10 may interface with membership process 12, thus allowing for a new Player's Club account to be generated 114 for patron 24.

Once the requisite identification information is received by enrollment process 10 and/or membership process 12, enrollment process 10 and/or membership process 12 may effectuate the generation 118 of a new membership card (not shown) for patron 24 that may be associated 120 with the new Player's Club account generated 114 for patron 24. Such a new Player's Club card may be generated 118 by e.g. printing device 38 coupled to e.g. network 30 and/or network 32. Alternatively, handheld electronic device 18 may be configured to generate 118 such a new Player's Club card.

Enrollment process 10 and/or membership process 12 may associate 122 a personal identification number (PIN) with the newly-created account or the existing account and/or with the membership card generated 118. For example, handheld electronic device 18 may be optionally equipped with a keypad, and a PIN may be entered on such a keypad. Patron 24 may enter the PIN either directly via the keypad or indirectly (by telling employee 20 the desired PIN). Once entered, the PIN may be associated 122 with the Player's Club account. Patron 24 may subsequently use the above-described PIN number to update various pieces of personal information, such as changing the PIN number, and changing a home address and telephone number.

Enrollment process 10 and/or membership process 12 may issue 124 a promotional credit to the Player's Club account, examples of which may include but are not limited to a promotional dollar amount, a credit for free meals, a credit for free drinks, and a credit for free accommodations.

While the system is described above as being utilized within a casino, this is for illustrative purposes only and is not intended to be a limitation of this disclosure, as other configurations are possible and are considered to be within the scope of this disclosure. For example, the above-described system may be utilized within a stadium or a theater.

A number of implementations have been described. Nevertheless, it will be understood that various modifications may be made. Accordingly, other implementations are within the scope of the following claims.

What is claimed is:

1. A method comprising:
defining identification information for a patron on a handheld device; and
providing the identification information for the patron to an enrollment process.

2. The method of claim 1 wherein defining identification information for a patron includes processing encoded identification data included within one or more of a magnetic strip, a bar code, an optical code, an image scan, a text scan, a fingerprint scan, a retinal scan, and an image of facial likeness.

3. The method of claim 2 further comprising:
retrieving at least a portion of the encoded identification data from one or more of a driver's license, a membership card, a passport, a social security card, a government-issued identification, and a privately-issued identification.

4. The method of claim 1 wherein providing the identification information for the patron to the enrollment process includes wirelessly transmitting the identification information for the patron to the enrollment process.

5. The method of claim 1 further comprising:
generating an account and associating the account with the patron.

6. The method of claim 1 further comprising:
generating a membership card and associating the membership card with an account.

7. The method of claim 1 further comprising:
associating a personal identification number with one or more of an account and a membership card.

8. A system configured to perform operations comprising:
defining identification information for a patron on a handheld device; and
providing the identification information for the patron to an enrollment process.

9. The system of claim 8 wherein defining identification information for a patron includes processing encoded identification data included within one or more of a magnetic strip, a bar code, an optical code, an image scan, a text scan, a fingerprint scan, a retinal scan, and an image of facial likeness.

10. The system of claim 9, wherein the system is further configured to perform operations comprising:
retrieving at least a portion of the encoded identification data from one or more of a driver's license, a membership card, a passport, a social security card, a government-issued identification, and a privately-issued identification.

11. The system of claim 8 wherein providing the identification information for the patron to the enrollment process includes wirelessly transmitting the identification information for the patron to the enrollment process.

12. The system of claim 8, wherein the system is further configured to perform operations comprising:
generating an account and associating the account with the patron.

13. The system of claim 8, wherein the system is further configured to perform operations comprising:
generating a membership card and associating the membership card with an account.

14. The system of claim 8, wherein the system is further configured to perform operations comprising:
associating a personal identification number with one or more of an account and a membership card.

15. A computer program product residing on a computer readable medium having a plurality of instructions stored thereon, which, when executed by one or more processors, cause the one or more processors to perform operations comprising:
defining identification information for a patron on a handheld device; and
providing the identification information for the patron to an enrollment process.

16. The computer program product of claim 15 wherein the instructions for defining identification information for a patron include instructions for processing encoded identification data included within one or more of a magnetic strip, a bar code, an optical code, an image scan, a text scan, a fingerprint scan, a retinal scan, and an image of facial likeness.

17. The computer program product of claim 16 further comprising instructions for:
retrieving at least a portion of the encoded identification data from one or more of a driver's license, a membership card, a passport, a social security card, a government-issued identification, and a privately-issued identification.

18. The computer program product of claim 15 wherein the instructions for providing the identification information for the patron to the enrollment process include instructions for wirelessly transmitting the identification information for the patron to the enrollment process.

19. The computer program product of claim 15 further comprising instructions for:
generating an account and associating the account with the patron.

20. The computer program product of claim 15 further comprising instructions for:
generating a membership card and associating the membership card with an account.

21. The computer program product of claim 15 further comprising instructions for:
associating a personal identification number with one or more of an account and a membership card.
